(19) United States
(12) Patent Application Publication
(10) Pub. No.: US 2015/0022595 A1
(43) Pub. Date: Jan. 22, 2015

(54) INK-SUPPLY DEVICE AND INK-PACK HOUSING CASE

(71) Applicants: Hyo-Chan LEE, Daegu (KR); Young-Suk KIM, Daegu (KR)

(72) Inventors: Young-Suk Kim, Daegu (KR); Hyo-Chan Lee, Daegu (KR)

(73) Assignee: IBLOCK P.A., Los Angeles, CA (US)

(21) Appl. No.: 14/386,757

(22) PCT Filed: Feb. 7, 2013
(86) PCT No.: PCT/KR2013/000978

§ 371 Date: Sep. 19, 2014

(30) Foreign Application Priority Data
Mar. 21, 2012 (KR) 10-2012-0028664

(51) Int. Cl. B41J 2/175

(52) U.S. Cl. CPC B41J 2/17506; B41J 2/17513
USPC 347/85

(57) ABSTRACT

An ink-supply device comprises: a body in which at least one housing space is formed and which is for housing at least one ink pack in the respective housing spaces; ink discharge tubes which are coupled to ink outlets of the respective ink packs; ink-supply tubes which are coupled to a cartridge; and a coupling members which are coupled between the ink-supply tubes and the ink discharge tubes linked to ink packs of the same color. A multiple loading type of ink-supply device is positioned below the cartridge such that excessive ink pressure does not occur in the cartridge and there is therefore the advantage that damage to the cartridge head can be prevented even without providing a separate damper.

### BACKGROUND

The present invention relates to an ink-supply device, and more particularly, to an ink-supply device in that a case having a plurality of multi-stacked ink packs is formed below the printer, so that it does not require a separate damper, thereby preventing a damage of the printer head owing to an ink pressure; an upper surface of the ink pack located at the lowest end portion thereof is attached to an upper portion of the housing or the case, so that the ink residual quantity is completely exhausted when the ink pack arranged on the upper end thereof is replaced; and the ink pack of the color frequently used according to the user-intensive can be selectively connected to be used.

In general, an ink jet printer is provided with a cartridge for supplying the ink in the printing process. Since only a certain amount of the ink is filled in the cartridge, it is necessary to replace it with a new cartridge when the ink is completely exhausted.

On the other hand, since the amount of the ink stored in the cartridge is very small, the use time thereof is not long. Also, the price thereof is also high. Accordingly, it is used by refilling the ink into the completely used cartridge. However, since the amount of the ink filled in the cartridge is very small, the use time thereof is short, thereby causing an inconvenience in use.

For this reason, at least one ink pack, in which the ink is stored, is connected to the cartridge in that the ink is exhausted so as to supply the ink thereto and the exhausted ink pack is replaced for refilling the ink.

FIG. 1 is a diagram illustrating a connecting structure of at least one ink pack for supplying an ink connected a cartridge according to the conventional art.

Referring to FIG. 1, it has a structure of connecting a first ink tube 300 and a second ink tube 310 connected to a first ink pack 200 and a second ink pack 210 having an ink respectively, which are located up and down, to a third ink tube 320 connected to a cartridge 600 by means of a connector 400.

In such a conventional manner, since the first ink pack 200 and the second ink pack 210 are located at the upper portion of the cartridge 600, the ink flowed from the first ink pack 200 and the second ink pack 210 is penetrated into the printer head even when the printer is not used, so that the printer head can be damaged. Accordingly, it is necessary to form a separate damper 500 at the third ink tube 320 so as to control the flow of the ink flowed from the first ink pack 200 and the second ink pack 210 when the printer 2 is not used. However, where the damper is out of order, since the ink flowed from the first ink pack 200 and the second ink pack 210 is penetrated into the printer head through the cartridge 600, there is a problem in that the printer head can be damaged.

Moreover, where the first ink pack 200 located at the upper portion thereof is replaced, since the ink stored in the first ink pack 200 is not completely exhausted to be remained, it can cause an ineffective problem in terms of money.

### SUMMARY OF THE INVENTION

Accordingly, the present invention has been made to solve the above-mentioned problems occurring in the prior art, and a object of the present invention is to provide an ink-supply device in that a multi-stacked ink-supply device is formed below a cartridge, so that an excessive ink pressure is not applied to the cartridge, thereby it does not require a separate damper.

Another object of the present invention is to provide an ink-supply device in that an upper surface of at least one ink pack is attached to an inner case, so that the ink of the ink pack attached to the upper surface of the case is exhausted at the end, thereby completely exhausting the inner inks of other ink packs for requiring replacement.

Further another object of the present invention is to provide an ink-supply device in that a separate aperture-adjusting valve is formed at the ink-supply tube, so that it can control the amount of the ink flowed into the cartridge and a coupling member is added thereto, so that the number of the ink packs of the same color can be selectively added according to the user-intensive.

In order to accomplish this object, there is provided an ink-supply device for supplying an ink to a printer comprising: a body having a plurality of housing spaces; cases housed in each housing space and having a space for housing an ink pack therein and an ink discharge hole formed at one side thereof so as to allow an ink outlet of the ink pack to be exposed to an outside thereof; ink discharge tubes connected to the ink outlets of each ink pack; ink-supply tubes connected to a cartridge; and coupling members coupled between the ink discharge tubes, which are coupled to the ink packs of the same color, and the ink-supply tube, wherein at least one ink pack among the ink packs of the same color housed in the cases is a filling ink pack and an upper surface thereof is attached and formed at one side of an upper portion of the case, so that the ink of other ink pack connected to the filling ink pack is sucked into an inside of the filling ink pack through each ink discharge tube when the printer is not used, thereby filling the filling ink pack with the ink.

Preferably, a sensor for sensing the residual quantity of the ink formed at one side of the case, in which the filling ink pack is accommodated.

Preferably, the sensor is any one of a touch sensor and a distance sensing sensor.

Preferably, the ink-supply device further comprises a residual quantity calculating portion for calculating the residual quantity of the ink pack based on the detecting signal detected by the touch sensor or the distance sensing sensor; and a displaying portion for displaying the residual quantity of the ink calculated by the residual quantity calculating portion on a screen thereof.

Preferably, the ink-supply tube further comprises an aperture-adjusting valve for adjusting the amount of the ink.

Preferably, the coupling member has multi direction branches or multi direction tubes and when the number of the ink packs of the same color is n, the n-tuple ink packs and the cartridge are connected by using three-way valves of n−1.

In order to accomplish this object, there is provided an ink-pack housing case for housing ink packs having an ink outlet therein comprising: an inner space for housing the ink pack; an ink discharge hole formed at one side thereof and corresponded to the ink outlet; and a fixing means for attaching an upper surface of the ink pack, thereby attaching the ink pack to the upper portion of the ink-pack housing case by means of the fixing means.

According to one aspect of the present invention, a multiple loading type of ink-supply device is positioned below the cartridge such that an excessive ink pressure does not occur in the cartridge and there is therefore the advantage that damage to the cartridge head can be prevented even without providing a separate damper.

According to another aspect of the present invention, the invention is configured in such a way that the upper surface of at least one of the ink packs is attached to an inner case, and the invention therefore has the advantage of being able to improve economic inefficiencies during ink-pack exchange as the ink pack attached to the case upper surface can be exhausted to the very end, and the ink inside the other ink packs for exchange can be completely exhausted.

According to yet another aspect of the present invention, a separate aperture-adjusting valve is provided towards the side where an ink-supply tube is located, such that the user can selectively regulate the ink volume and print quality by adjusting the volume of ink flowing into the cartridge, and the coupling member is added such that, in use, a number of ink packs of the same color can be selectively coupled as the user wishes and thus the invention has the advantages of being able to provide an ink-supply device matched to the user

### BRIEF DESCRIPTION OF THE DRAWINGS

The above and other objects, features and advantages of the present invention will be more apparent from the following detailed description taken in conjunction with the accompanying drawings, in which:

FIG. 1 is a cross-section view illustrating a connecting structure between the conventional ink pack and cartridge.

FIG. 2 is an entire perspective view illustrating an ink-supply device according to the present invention;

FIG. 3 is an exploded perspective view illustrating a coupling relation between an outer case, an inner case, and an ink pack of the ink-supply device according to the present invention;

FIG. 4 is a perspective view illustrating a relation of connecting an upper surface of an ink pack to an inner case according to the present invention;

FIG. 5 is a cross-sectional view illustrating a state in that an upper portion of the ink-pack is coupled to the inner case of the ink-supply device according to the invention;

FIG. 6 is a conceptual diagram illustrating the entire connection structure of an ink-supply device according to the present invention; and

FIG. 7 and FIG. 8 are conceptual diagrams illustrating the connection structure of an ink-supply device according to the present invention when the ink packs of the same color are added thereto.

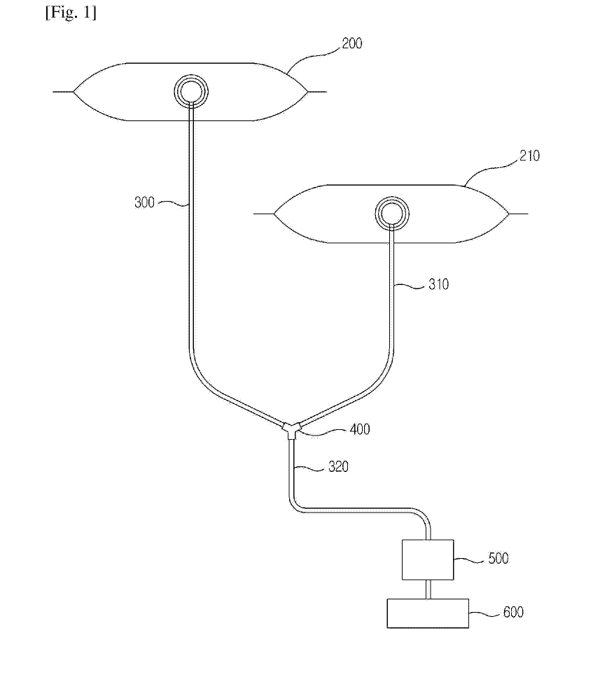

### DETAILED DESCRIPTION OF THE INVENTION

Hereinafter, an exemplary embodiment of the present invention will be described in detail with reference to the accompanying drawings.

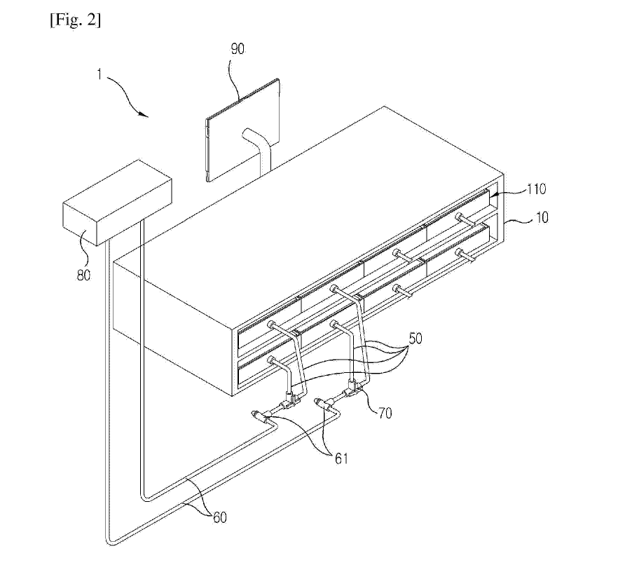

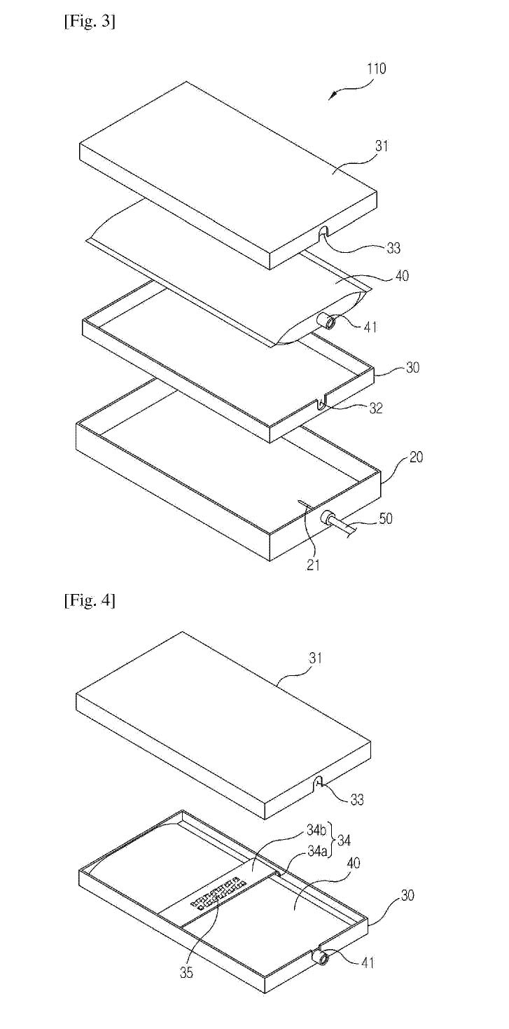

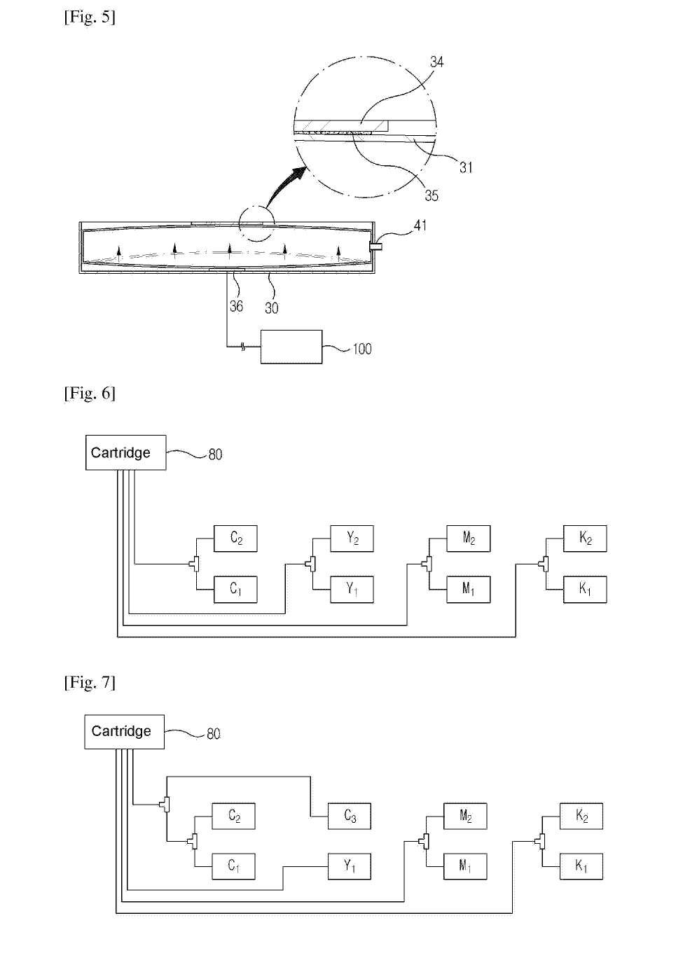

FIG. 2 is an entire perspective view illustrating an ink-supply device according to the present invention, FIG. 3 is an exploded perspective view illustrating a coupling relation between an outer case, an inner case, and an ink-pack of the ink-supply device according to the present invention, FIG. 4 is a perspective view illustrating a relation of connecting an upper surface of an ink pack to an inner case according to the present invention, and FIG. 5 is a cross-sectional view illustrating a state in that an upper portion of the ink pack is coupled to the inner case of the ink-supply device according to the invention.

Referring to FIG. 2 and FIG. 3, the ink-supply device 1 according to the invention includes a body 10 having a shelf structure provided with a two-layer housing space and housing at least one ink pack, which has an ink outlet at one side thereof, in the housing spaces of each story; ink discharge tubes 50 coupled to the ink outlets 41 of the respective ink pack 40; ink-supply tubes 60 coupled to a cartridge 80; coupling members 70 coupled between the ink-supply tubes 60 and the ink discharge tubes 50; and a displaying portion 90.

As described above, the body 10 has a shelf structure provided with the two-layer housing space. Also, the body 10 serves to house ink-pack housing cases 110 having each ink pack 40 in the housing spaces of each layer respectively. If necessary, it can be provided with the housing space more than three-layer.

Here, due to the two-layer stacked shelf structure thereof, one ink pack 40 housed in the upper ink-pack housing case 110 and other ink packs 40 housed in the lower ink-pack housing case 110 can sequentially exhaust the ink thereof.

Also, the body 10 is located at the lower portion of the cartridge 80, so that the ink is not flowed into the cartridge 80 owing to the ink pressure of the ink accommodated in the ink pack 40 during the disuse of the corresponding printer unlike the conventional ink-supply device, which is located at the upper portion the cartridge. Accordingly, it can prevent the problem in that the printer head is damaged owing to the ink, which is flowed into the printer head via the cartridge 80.

Moreover, there is an advantage in that it does not provide a separate damper for controlling the flow of the ink when the printer is not used.

Furthermore, the ink packs 40 housed in the ink-pack housing cases 110, which are opposed to each other in the vertical direction, accommodate the same ink and other ink packs 40 housed in the ink-pack housing cases 110, which are arranged in a low, accommodate the inks of a different color 40.

A pair of the ink discharge tubes 50 includes one end connected to the ink-pack housing cases 110 having the inks of the same color and other end coupled to multi direction valves 70, thereby providing a flow path for supplying the ink between the ink-pack housing cases 110 and the multi direction valve 70.

The ink-supply tube 60 includes one end coupled to a multi direction valve 70 and other end coupled to the cartridge 80, thereby providing a flow path for supplying the ink between the multi direction valve 70 and the cartridge 80.

Also, the ink-supply tube 60 further includes an aperture-adjusting valve 61 for adjusting the aperture degree of the ink-supply tube 60 formed at one side thereof.

The user can selectively control the aperture-adjusting valve 61, thereby arbitrarily adjusting the ink supplies. Accordingly, it is possible to selectively adjust the print quality thereof.

The coupling member 70 serves as a connection between the ink-supply tubes 60 and the ink discharge tubes 50. The coupling member 70 can include multi direction branches and multi direction tubes. The present invention will be described on only the three-way valves among the multi direction valves.

Here, since the coupling member 70 includes the three-way valve, it is possible to selectively open and close the connection between the ink discharge tube 50 and the ink-supply tube 60 by switching the direction of the three-way valve

On the other hand, the ink pack 40 of a rectangular shape includes an ink outlet 41 formed at one side thereof. Also, the ink pack 40 is a type of a pack capable of contracting according to the discharge of the ink accommodated therein. Also, the ink pack 40 serves to block the air flowed into the inside thereof, thereby maintaining the quality of the ink contained in the ink pack 40.

As described above, the ink packs 40 can be housed in the ink-pack housing cases 110 of the body 10. The ink-pack housing case 110 includes an inner case 30, an inner case cover 31, an outer case 20, and a fixing member 34.

The inner case 30 includes an inner space for accommodating the ink pack 40. The inner case 30 is in the form of an open-top rectangular parallelepiped. Also, the inner case 30 includes a through hole 32 formed at one side thereof and corresponded to the ink outlet 41 of the ink pack 40 so as to accommodate the ink pack 40 therein. The ink outlet 41 of the ink pack 40 is inserted into the through hole 32 of the inner case 30, so that the ink pack 40 is accommodated in the inner space of the inner case 30 while exposing it to outside.

The inner case cover 31 is in the form of an open-bottom rectangular parallelepiped and a litter larger than the inner case 30. Also, the inner case cover 31 includes a cut groove 33 formed at one side thereof and corresponded to the through hole 32 of the inner case 30. Accordingly, the ink outlet 41 of the ink pack is coupled to the outer surface of the side wall of the inner case 30 through the cut groove 33 while exposing it to the outside of the inner case 30.

The outer case 20 includes a hosing space formed at an inside thereof and is in the form of an open-top rectangular parallelepiped. Also, the outer case 20 includes an ink injection needle 21 formed at one side thereof and corresponded to the ink outlet 41 of the ink pack 40, so that the ink outlet 41 is connected to the ink injection needle 21 so as to discharge the ink to the outside.

As shown in FIG. 4 and FIG. 5, the fixing member 34 includes a pair of vertical portions 34a extending from the bottom surfaces of the inner walls of both sides of the inner case 30 to the upper ends thereof and a horizontal connecting portion 34b for horizontally connecting the upper ends of the pair of vertical portions 34a to each other. Also, an adhesive member 35, which is formed at the lower surface of the horizontal connecting portion 34b, is attached to the upper surface of the ink pack 40 to form an upper surface adhesive structure of the ink pack 40.

The ink pack 40 attached to the fixing member 34 is contracted from the lower portion thereof toward the upper portion thereof as the ink is exhausted. This structure has a function for sucking the ink inside the ink pack 40, unlike the conventional structure in that the ink pack 40, which is seated on the lower portion of the inner case, is contracted from the upper portion thereof toward the lower portion thereof.

Where the ink pack 40 of the upper surface adhesive structure is located at the lower end of the ink-supply device having a two-layer stacking structure, the inner ink of the ink pack 40 of the upper surface adhesive structure, which is located at the lower end thereof and the inner ink of other ink pack 40, which is located at the upper end thereof can be discharged to the outside through the ink discharge tube and the ink-supply tube, which are connected to each other through the coupling member during the using of the printer. Also, when the printer is not used, the inner inks of other ink packs 40, which are connected to each other through each ink discharge tube are flowed into the inside of the ink pack 40 of the upper surface adhesive structure to fill it with the ink, so that the inner inks accommodated in other ink packs 40 are completely exhausted, without leaving the remaining amount thereof. Accordingly, it is possible to solve the problem that the ink is remained in the inside of other ink packs 40 during the replacement thereof.

Accordingly, since the inner inks accommodated in the ink packs 40 are completely exhausted, without leaving the remaining amount thereof, there is an advantage in that it can reduce the costs thereof owing to a long replacement period of the ink pack 40.

Even if the ink pack 40 of the upper surface adhesive structure is located at the upper end or any location of the ink-supply device, the inner inks of other ink packs 40 can be discharged to the outside together during the using of the printer. Also, when the printer is not used, since the inner inks of other ink packs 40 are flowed into the inside of the ink pack 40 of the upper surface adhesive structure to fill it with the ink, it is always exhausted at the end.

Also, in case of the stacking structure more than three-layer, the ink pressure is excessively increased to the number of the added ink packs 40, the aperture-adjusting valve 61, which is formed at one side of the ink-supply tube 60, cannot be finely adjusted. At this time, at least two ink packs 40 of the upper surface adhesive structure is formed therein, so that the excessive ink pressure applied to the ink-supply tube 60 can be reduced, thereby finely adjusting the aperture-adjusting valve 61, which is formed at the ink-supply tube 60.

On the other hand, in this embodiment of the present invention, it further includes a sensor 36 formed at one side of the lower surface of the ink-pack housing case 110, in which the ink pack 40 of the upper surface adhesive structure is accommodated, and a residual quantity calculating portion 100 for calculating the residual quantity of the ink pack 40 based on the detecting signal detected by the sensor 36, and a displaying portion 90 for displaying the residual quantity of the ink calculated by the residual quantity calculating portion 100 on a screen thereof.

Here, the sensor 36 may be a touch sensor or a distance sensing sensor. Also, it may be used as a combination type thereof.

In case of the touch sensor, it is located at one side of the lower surface of the inner case 30, in which the ink pack 40 of the upper surface adhesive structure is accommodated, and is in contact with the lower portion of the ink pack 40 of the upper surface adhesive structure. At this time, as the ink existed in the ink pack 40 is exhausted, the touch sensor is separated from the lower portion of the ink pack 40. Accordingly, the touch sensor notifies the complete exhaustion of the inks accommodated in other ink packs 40 other than the ink pack 40 of the upper surface adhesive structure through the displaying portion 90, so that it serves to inform the user of the replacement time of other ink packs 40. Also, when the touch sensor is separated from the lower portion of the ink pack 40, the residual quantity of the ink pack 40 can be experimentally measured, so that it can notify the residual quantity of the ink through the displaying portion.

In case of the distance sensing sensor, as the ink existed in the ink pack 40 of the upper surface adhesive structure is exhausted, the ink pack 40 is contracted from the lower portion thereof toward the upper portion thereof. At this time, after it detects the separating distance between the distance sensing sensor and the lower surface of the ink pack 40 and the residual quantity of the ink pack 40 is calculated through the residual quantity calculating portion 100, the residual quantity of the ink calculated by the residual quantity calculating portion 100 is displayed on the screen through the displaying portion 90. In this case, there is an advantage in that it can continuously notify the residual quantity of the ink, as the detecting distance is changed.

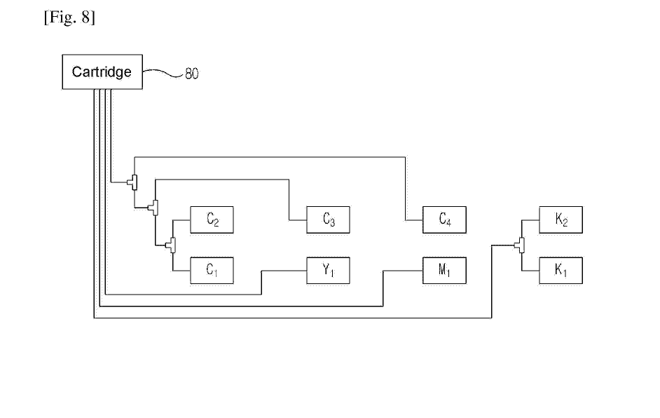

FIG. 6 is a conceptual diagram illustrating the entire connection structure of an ink-supply device according to the present invention and FIG. 7 and FIG. 8 are conceptual diagrams illustrating the connection structure of an ink-supply device according to the present invention when the ink packs of the same color are added thereto.

The colors of the ink generally used in the printer include a cyan (C), a yellow-green (Y), a magenta (M), and a black (K). The ink-pack housing cases 110, in that the ink packs having each color is accommodated, are arranged in a row.

In this embodiment, the ink-pack housing cases 110, in that the inks having each color are accommodated, have a vertical two-layer stacking structure. For example, in the case of the cyan, a C1 is disposed below and a C2 is placed on the upper portion thereof. Also, in case of different color inks, they are disposed as the same stacking structure.

That is, in the yellow-green, an Y1 is disposed below and an Y2 is placed on the upper portion thereof. Also, in the magenta, a M1 is disposed below and a M2 is placed on the upper portion thereof. In case of the black, a K1 and a K2 are vertically stacked.

Here, the C1 and C2, the Y1 and Y2, the M1 and M2, and the K1 and K2 of the same color are connected to the coupling member 70 through the ink discharge tubes 50 respectively to be gathered. The gathered inks are supplied to the inside of the cartridge 80 through each ink-supply tube 60 connected between the coupling member 70 and the cartridge 80.

Referring to the FIG. 6, each ink discharge tube 50, which is connected to the C1 and C2 of the same color, is connected to the three-way valve and the three-way valve is connected to the cartridge 80 by means of the ink-supply tube 60, so that the inks of the same color are supplied to the cartridge 80 through the ink discharge tube 50 and the ink-supply tube 60.

Also, the Y1 and Y2, the M1 and M2, and the K1 and K2 of the same color are supplied to the cartridge 80 through the ink discharge tube 50 for connecting the ink packs of the same color to the three-way valve and the ink-supply tube 60 for connecting between the three-way valve and the cartridge.

In this basic structure, since the ink amount of each color is fixed, a well-used color according to the user-intensive cannot be used selectively. For example, where the well-used color is the cyan (C) according to the user-intensive, it is inconvenient to frequently replace the cyan ink (C).

Therefore, the replacement period of the ink packs 40 of each color is uneven, so that the number of times replacing the ink pack 40 is increased, thereby deteriorating the efficiency of the replacement work.

Referring to FIG. 7, where the well-used color is the cyan (C) according to the user-intensive, the ink packs 40 for the C1 and C2 are connected to the three-way valve, the Y2 is replaced with a C3 identical with the C1 and C2 in terms of the color, and another three-way valve other than the three-way valve connected to the C1 and C2 is added thereto, so that the C1, C2, and C3 are connected to each other and supplied to the cartridge, thereby mating the replacement time of the cyan ink packs and the replacement time of other color ink packs. Accordingly, it can reduce the inconvenience generated owing to the different replacement time according to the colors of the ink packs.

Referring to FIG. 8, where the cyan color (C) is used more by means of the user, the M2 is replaced with a C4 and another three-way valve is added thereto, so that they are connected to each other. That is, whenever the ink pack of the same color is added, another three-way valve is added thereto.

As described above, the ink pack of the same color and the three-way valve for connecting the ink packs of the same color to each other are simultaneously added thereto, so that it is possible to control the number of the ink packs of the well-used color according to the user-intensive.

That is, when the n-tuple ink packs of the same color are installed and used in the ink-supply device, the n-tuple ink packs and the cartridge can be connected by using the three-way valves of n−1.

In addition, the amount of the ink packs of the well-used color and the amount of other ink packs having different colors can be adjusted, so that the replacement time of the ink packs can be controlled and thus it has the advantages of being able to provide the ink-supply device matched to the user.

As described above, the ink-pack housing cases 110 are multi-stacked in the housing space of the body 10. However, the present invention is necessarily limited thereto. That is, the body 10 is omitted and the ink-supply device can be provided with only at least one ink-pack housing cases 110 stacked in the form of a single-stage or multi-stage housing case 110.

Although a preferred embodiment of the present invention has been described for illustrative purposes, those skilled in the art will appreciate that various modifications, additions and substitutions are possible, without departing from the scope and spirit of the present invention as disclosed in the accompanying claims.

The present invention relates to an ink-supply device in that the upper surface of at least one ink pack is attached to the inner case, so that it has a function of sucking the ink of the ink pack for replacement, thereby completely exhausting the inner inks of other ink packs for requiring replacement and can be usefully used in the fields of household and industrial inkjet printers and so on.

1. An ink-supply device for supplying an ink to a printer comprising:
a body having a plurality of housing spaces;
cases housed in each housing space and having a space for housing an ink pack therein and an ink discharge hole formed at one side thereof so as to allow an ink outlet of the ink pack to be exposed to an outside thereof;
ink discharge tubes connected to the ink outlets of each ink pack;
ink-supply tubes connected to a cartridge; and
coupling members coupled between the ink discharge tubes, which are coupled to the ink packs of the same color, and the ink-supply tube,
wherein at least one ink pack of the ink packs of the same color housed in the cases is a filling ink pack and an upper surface thereof is attached and formed at one side of an upper portion of the case, so that the ink of other ink pack connected to the filling ink pack is sucked into an inside of the filling ink pack through each ink discharge tube when the printer is not used, thereby filling the filling ink pack with the ink.

2. An ink-supply device as claimed in claim 1, wherein a sensor for sensing the residual quantity of the ink formed at one side of the case, in which the filling ink pack is accommodated.

3. An ink-supply device as claimed in claim 2, wherein the sensor is any one of a touch sensor and a distance sensing sensor.

4. An ink-supply device as claimed in claim 3, further comprising a residual quantity calculating portion for calculating the residual quantity of the ink pack based on the detecting signal detected by the touch sensor or the distance sensing sensor; and
a displaying portion for displaying the residual quantity of the ink calculated by the residual quantity calculating portion on a screen thereof.

5. An ink-supply device as claimed in claim 1, wherein the ink-supply tube further comprises an aperture-adjusting valve for adjusting the amount of the ink.

6. An ink-supply device as claimed in claim 1, wherein the coupling member has multi direction branches or multi direction tubes and, when the number of the ink packs of the same color is n, the n-tuple ink packs and the cartridge are connected by using three-way valves of n−1.

7. An ink-pack housing case for housing ink packs having an ink outlet therein comprising:
an inner space for housing the ink pack;
an ink discharge hole formed at one side thereof and corresponded to the ink outlet; and
a fixing means for attaching an upper surface of the ink pack, thereby attaching the ink pack to the upper portion of the ink-pack housing case by means of the fixing means.
